(19) United States
(12) Patent Application Publication
(10) Pub. No.: US 2015/0181349 A1
(43) Pub. Date: Jun. 25, 2015

(54) Microphone Circuit And Motor Assembly

(71) Applicant: Knowles Electronics LLC, Itasca, IL (US)

(72) Inventors: George Patterson, JR., Lombard, IL (US); Dennis R. Kirchhoefer, Plainfield, IL (US); Janice LoPresti, Itasca, IL (US); Felix Naylor, Chicago, IL (US)

(21) Appl. No.: 14/570,551

(22) Filed: Dec. 15, 2014

Related U.S. Application Data
(60) Provisional application No. 61/918,002, filed on Dec. 19, 2013.

(51) Int. Cl. H04R 19/01

(52) U.S. Cl. CPC H04R 19/016

(57) ABSTRACT

An acoustic motor assembly includes a substrate with a diaphragm ring that is integrally formed with the substrate. The diaphragm ring forms an opening extending through the substrate. The assembly also includes an electrically charged plate extending over the opening; a diaphragm extending over the opening and vertically displaced from the electrically charged plate; and a stitch coupling the electrically charged plate to the diaphragm. Sound energy creates a movement of the diaphragm, and the movement is effective to create an electrical signal representative of the sound energy.

### CROSS REFERENCE TO RELATED APPLICATION

This patent claims benefit under 35 U.S.C. §119 (e) to United States Provisional Application No. 61918002 entitled “Microphone and Circuit and Motor Assembly” filed Dec. 19, 2013, the content of which is incorporated herein by reference in its entirety.

### TECHNICAL FIELD

This application relates to Electret Condenser Microphone (ECM) devices and, more specifically, to the construction and configuration of the substrates in these devices.

### BACKGROUND OF THE INVENTION

In the case of an Electret Condenser Microphone (ECM), sound energy enters through a sound port and vibrates a diaphragm and this action creates a corresponding change in electrical potential (voltage) between the diaphragm and a charged back plate disposed near the diaphragm. This voltage represents the sound energy that has been received. Typically, the voltage is then transmitted to an electric circuit (e.g., an integrated circuit such as an application specific integrated circuit (ASIC)). Further processing of the signal may be performed on the electrical circuit. For instance, amplification or filtering functions may be performed on the voltage signal at the integrated circuit.

The ECM includes an electret based motor. The electret based motor typically includes the diaphragm and charged back plate. A ceramic substrate is typically used for the integrated circuit. In these assemblies, a diaphragm ring and other extra components are used. The use of a separate diaphragm ring adds additional complexity to the system. For example, the diaphragm ring is an extra part that requires an extra step in the manufacturing process to install. In today's manufacturing environment it is extremely desirable to minimize the costs of the devices produced. Additional parts necessarily increase the cost of the ECM device and this has become undesirable under many circumstances.

### BRIEF DESCRIPTION OF THE DRAWINGS

For a more complete understanding of the disclosure, reference should be made to the following detailed description and accompanying drawings wherein:

FIG. 1 comprises a top exploded view of an ECM assembly according to various embodiments of the present invention;

FIG. 2 comprises a bottom exploded view of the ECM assembly of FIG. 1 according to various embodiments of the present invention;

FIG. 3 comprises a top perspective view of a circuit and motor combination of FIG. 1 and FIG. 2 incorporating a diaphragm ring into a ceramic substrate according to various embodiments of the present invention;

FIG. 4 comprises a bottom perspective view of the circuit and motor combination of FIG. 1, FIG. 2., and FIG. 3 incorporating a diaphragm ring into a ceramic substrate according to various embodiments of the present invention;

FIG. 5 comprises a top perspective view of another circuit motor combination incorporating a diaphragm ring into a ceramic substrate according to various embodiments of the present invention;

FIG. 6 comprises a bottom perspective view of the circuit motor combination of FIG. 5 incorporating a diaphragm ring into a ceramic substrate according to various embodiments of the present invention;

FIG. 7 comprises a cutaway perspective view of another ECM assembly according to various embodiments of the present invention;

FIG. 8 comprises a top exploded view of another ECM assembly according to various embodiments of the present invention;

FIG. 9 a perspective cutaway view of a hearing aid module including an ECM assembly according to various embodiments of the present invention;

FIG. 10 comprises a perspective view of the hearing aid module of FIG. 9 according to various embodiments of the present invention;

FIG. 11 comprises a exploded perspective view of a double sided ceramic diaphragm according to various embodiments of the present invention;

FIG. 12 comprises a side view of a double sided ceramic diaphragm of FIG. 11 according to various embodiments of the present invention;

FIG. 13 comprises a side cutaway view of the diaphragm assembly of FIGS. 11 and 12 in a housing according to various embodiments of the present invention;

FIG. 14 comprises a front perspective view of a side-by-side ceramic diaphragm assembly according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

The approaches presented herein provide a circuit and motor combination with a diaphragm ring that is physically integrated with the substrate. By “integrated,” it is meant that the substrate and ring are formed together, made of the same material, and/or are contiguous. A simplified circuit and motor assembly are provided. Separate diaphragm rings needed and present in previous systems are eliminated. In some aspects, the diaphragm ring is incorporated into a ceramic substrate.

In many of these embodiments, an extended ceramic substrate is used with an opening for the motor. As used herein, “motor” refers to the diaphragm and charged back plate. An opening may be created in a ceramic substrate, for example, by punching the ceramic substrate to form the diaphragm ring of the motor. A ground plane can be created on both the top and bottom portions connecting the diaphragm ring directly to the circuit ground. Consequently, no wire or cement (for example) is needed to couple the ring to the ground plane.

In some advantages of the present approaches, a drop through assembly is provided. A reduced-sized part is provided since a separate diaphragm is not used. A standalone circuit and motor assembly could be provided to a customer, for example, in customer's face plate. Different size options are provided depending upon the desired mechanical outline and electroacoustic performance. A wire bond is provided from the circuit to the charged back plate and this is advantageous because two assembly operations are combined into one operation. Parasitic capacitance in the motor assembly is reduced because beyond the diaphragm and statically charged back plate, there are no other conductive surfaces that form capacitive constructions. Reduced parasitic capacitance is beneficial because it increases the gain of motor. The need to insulate the edge of the back plate from the diaphragm ring is also eliminated since surface is non-conductive.

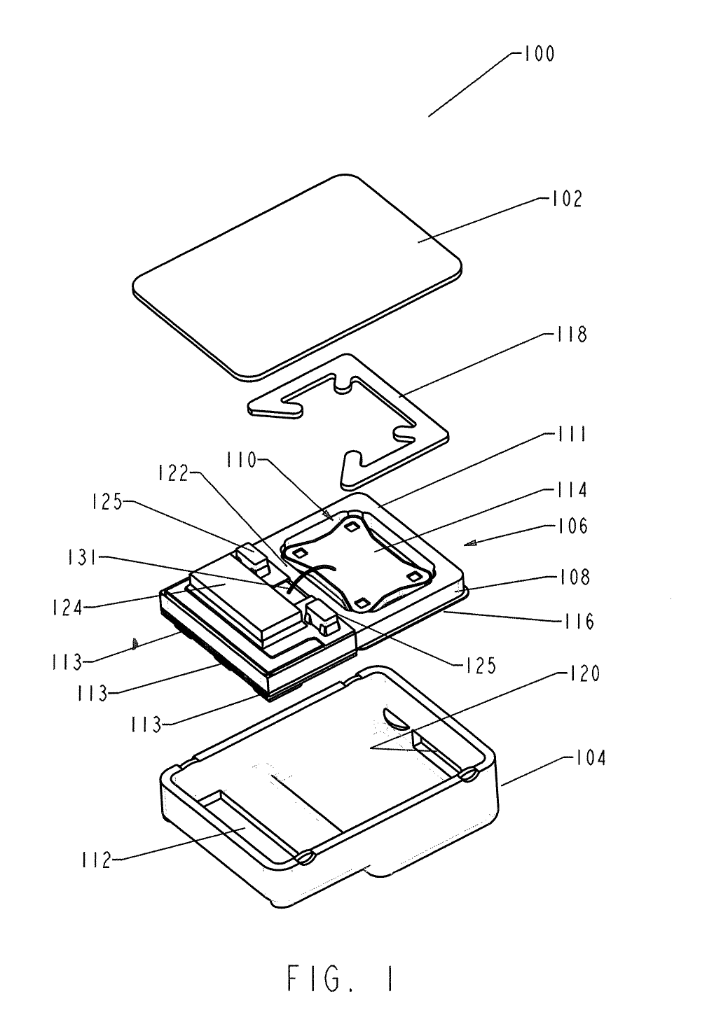

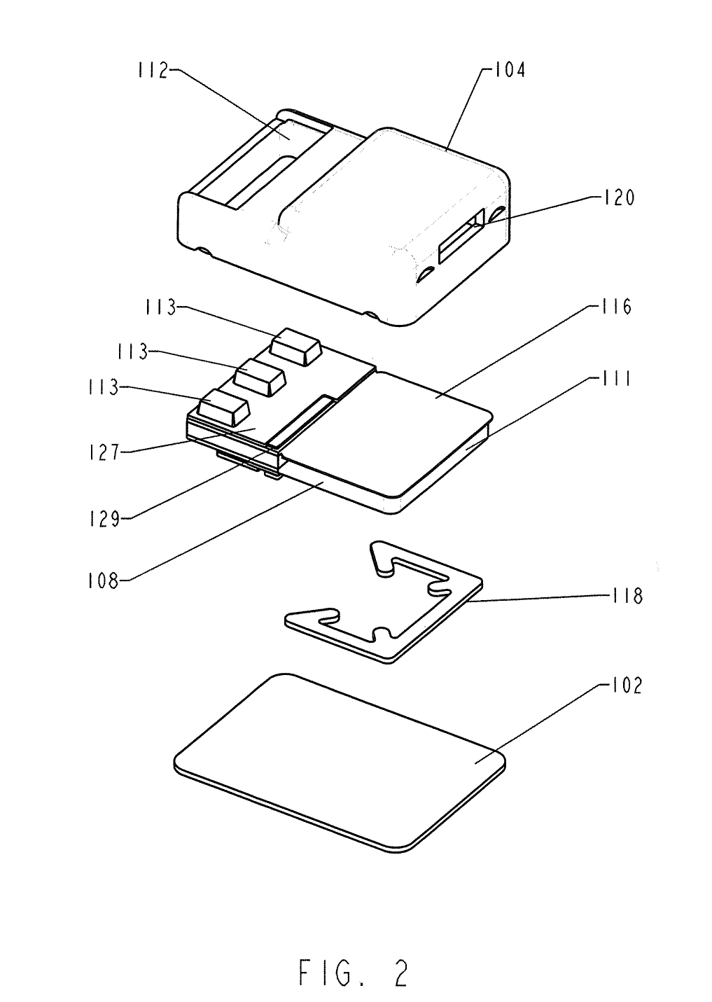

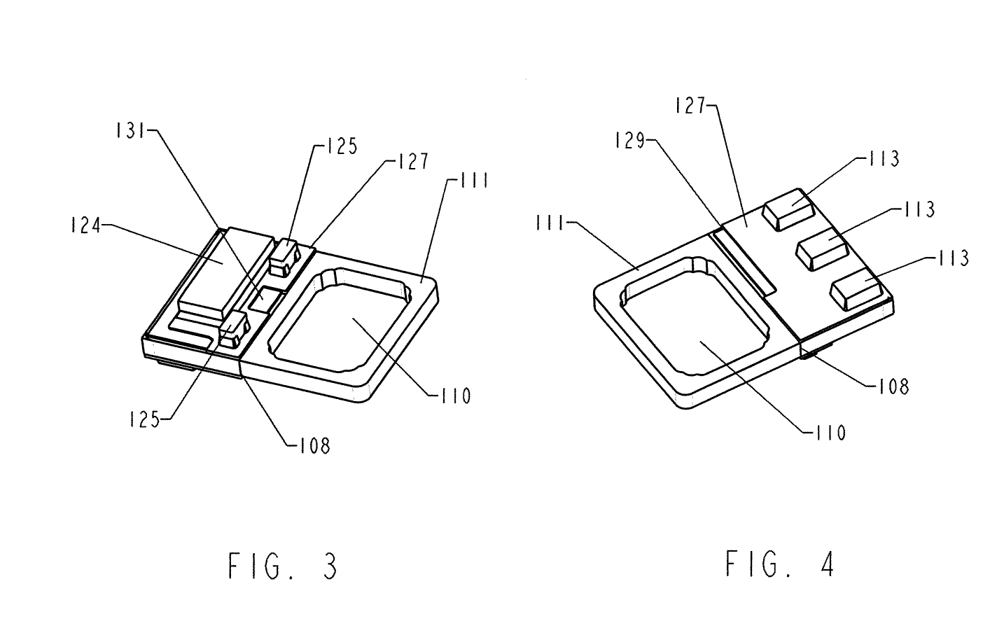

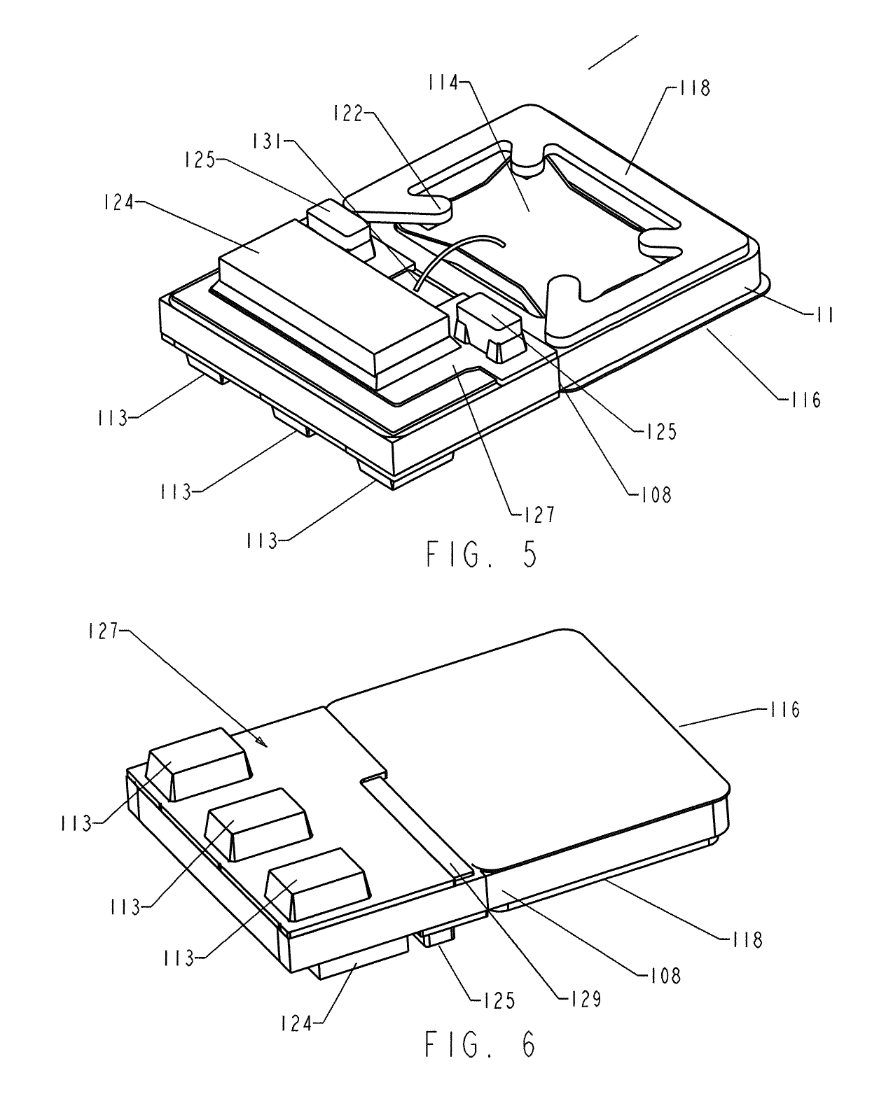

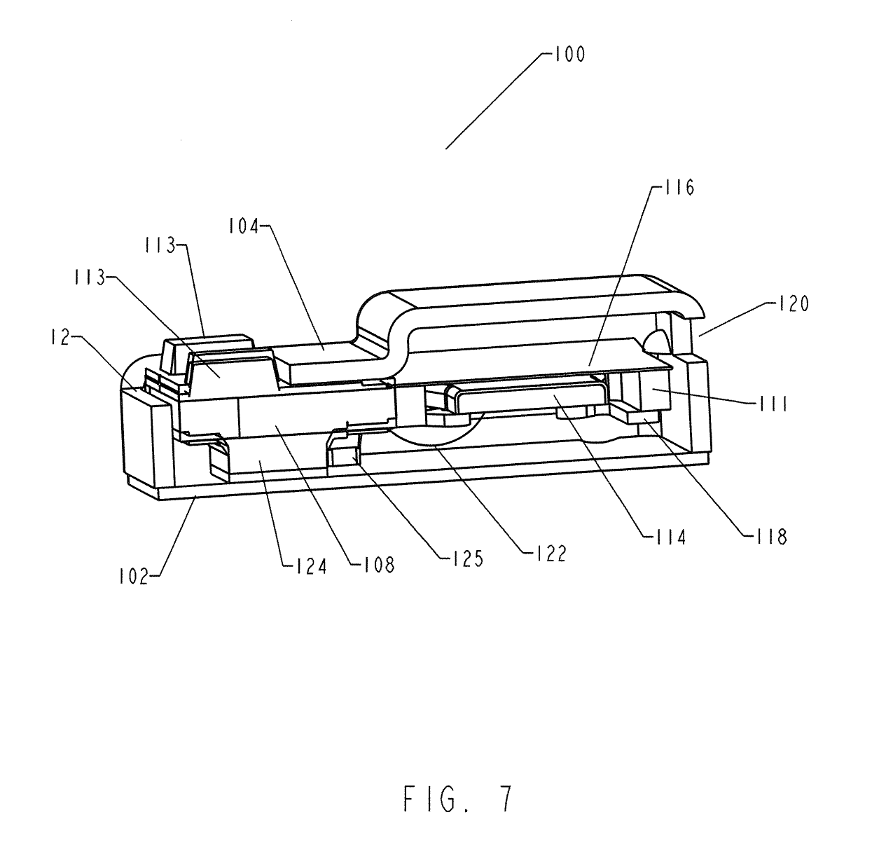

Referring now to FIGS. 1-7, one example of an ECM assembly is described. The assembly 100 includes a housing comprised of a top cover 102 and a bottom cover 104, and a motor-circuit assembly 106 which includes epoxy 118.

The substrate 108 of the motor-circuit assembly 106 includes terminals 113 for signal, ground and power supply connections that protrude through an opening 112 in cover 104. The terminals 113 may be constructed of metal pads in one example.

Disposed over the opening 110 on substrate 108 are a back plate 114, a diaphragm 116, and epoxy 118. The epoxy between the charge plate and diaphragm provides mechanical support and is sometimes referred to as a “stitch” due to its shape. A small bead of epoxy may be dispensed from a hypodermic needle to form the stitch at the four corners of the charge plate 114 (not shown). The epoxy “stitch” 118 may also be constructed of a conjoined B-stage adhesive and a polyimide (e.g., Kapton) as shown in figures which is configured to secure the charged back plate 114 to the assembly 106. The construction of the charged back plate 114 and the diaphragm 116 are well known to those skilled in the art. The substrate 108 may in one example be a ceramic substrate and includes a diaphragm ring 111 (which is part of and incorporated with the substrate). In one aspect, the diaphragm ring 111 may be approximately 0.10 inches thick. Other dimensions may also be used. A wire 122 forms an electrical connection between the charged back plate 114 and an integrated circuit 124 (e.g., an application specific integrated circuit (ASIC)). The integrated circuit 124 may perform various processing functions such as amplifying the voltage produced. Capacitors 125 may be attached to the integrated circuit. A glass coating 127 may be applied to insulate and protect areas of circuit. A ground layer 129 may be exposed to provide an area that can be used to form a ground connection between the circuit 124 and cover 104. A conduction pad 131 couples the wire 122 to the charged back plate 114 and the integrated circuit 124. A sound port 120 is formed in the bottom cover 104 and allows sound into the assembly 100.

In one example of the operation of the system of FIGS. 1-7, sound energy enters through the sound port 120 and vibrates the diaphragm 116 and this action creates a corresponding change in electrical potential (voltage) between the diaphragm 116 and the charged back plate 114. This voltage represents the sound energy that has been received. The voltage is transmitted via the wire 122 to the integrated circuit 124 where further processing of the signal may be performed. For instance, amplification or filtering functions may be performed on the voltage signal at the integrated circuit.

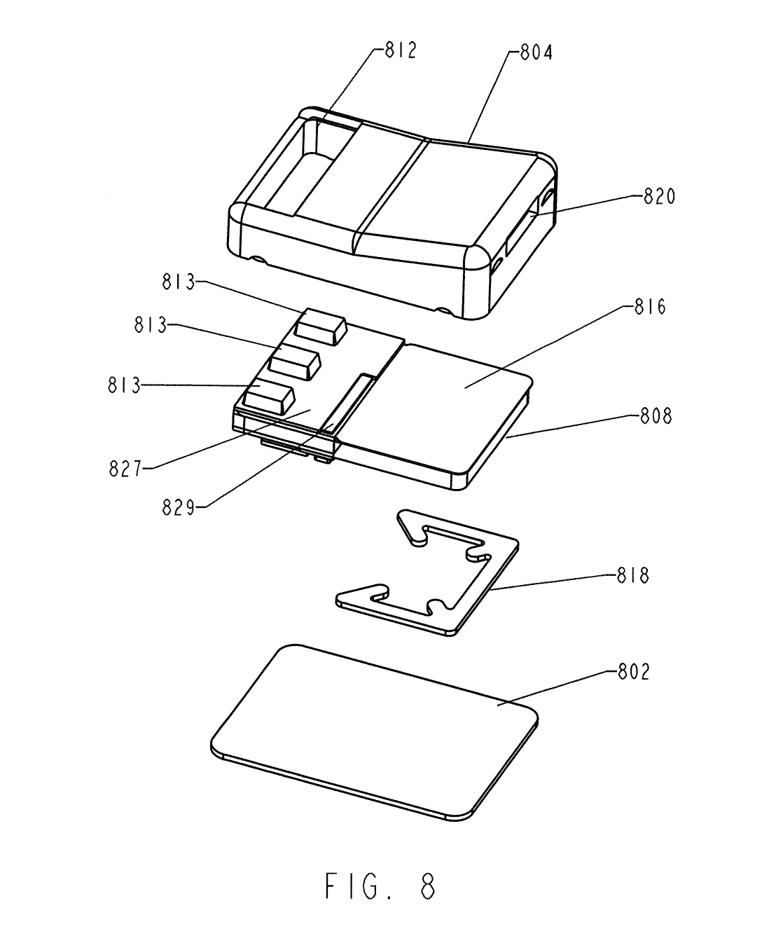

Referring now to FIG. 8, one example of an ECM assembly is described. In this example, a step in housing is not used. Instead, cover 804 has a slanted portion that is used to connect sound inlet 820 to diaphragm 816 without impeding air flow. The other components are the same as those referred to in the example of FIGS. 1-7 and like-numbered elements in FIG. 8 refer to similar elements in FIGS. 1-7.

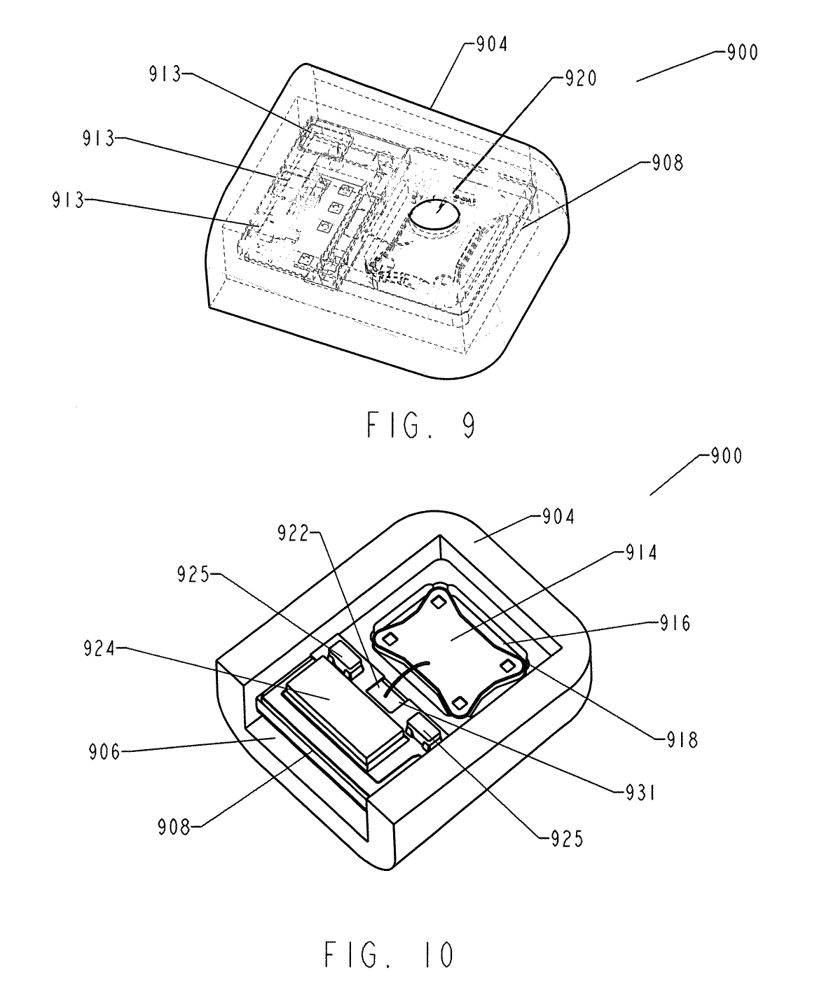

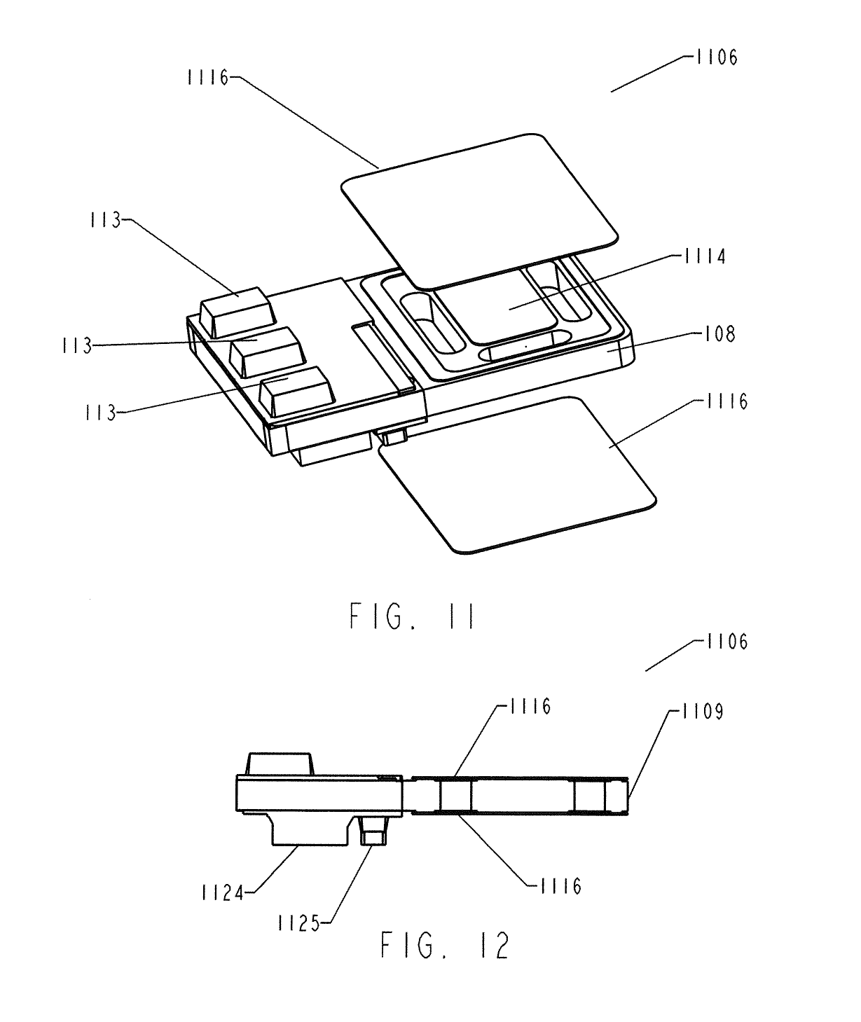

Referring now to FIG. 9 and FIG. 10, one example of a face plate module (e.g., as used in a hearing aid) including an ECM assembly is described.

The face plate module 900 includes an ECM motor-circuit assembly 906, and an outer housing portion 904. The face plate module 900 may be used and attached to other housings or other components for example to form a hearing aid. The ECM motor-circuit assembly 906 includes a back plate 914, a diaphragm 916, and epoxy for mechanical support of plate 918. It also includes integrated circuit 924 and capacitors 925. The other components are the same as those referred to in the example of FIGS. 1-7 and like-numbered elements in FIG. 9 refer to similar elements in FIGS. 1-7.

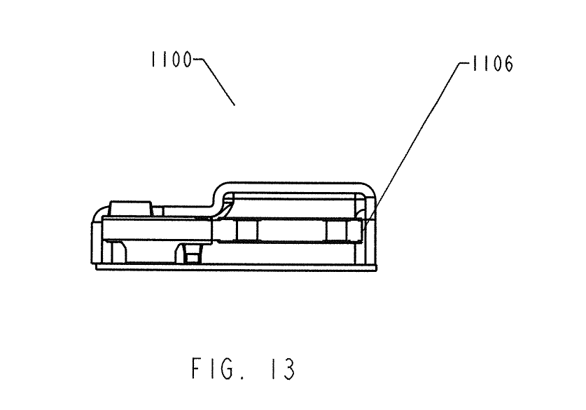

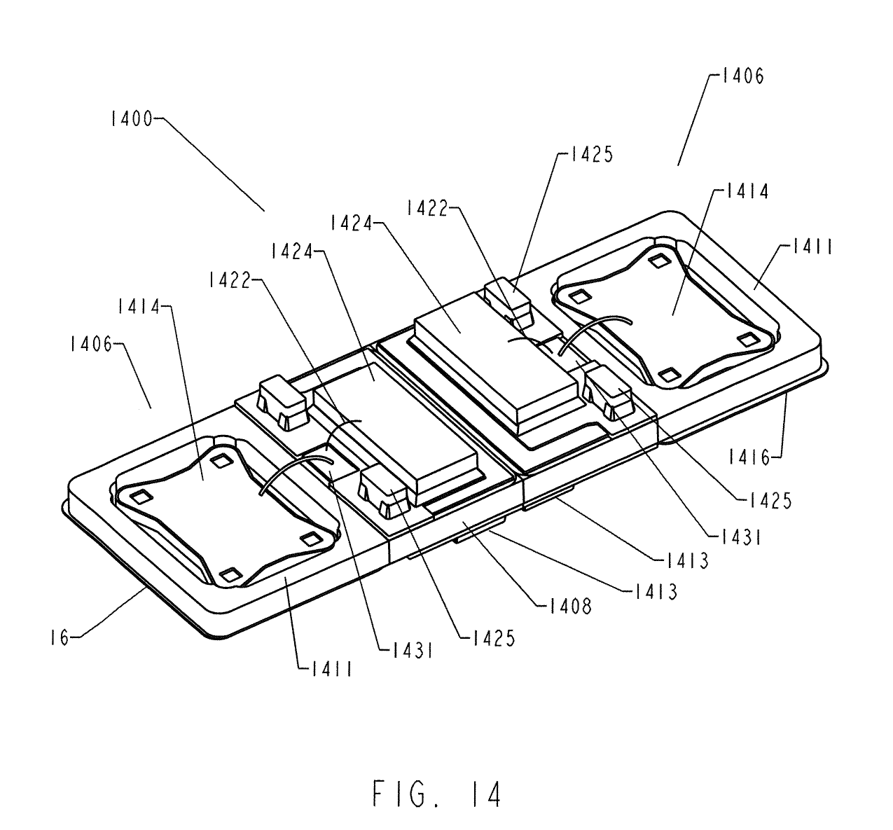

Referring now to FIG. 11-13, one example of a motor and circuit assembly 1106 that includes a double-sided motor is described. A substrate 1108 has attached to it charge plates or coatings applied to surfaces that is charged and are on opposite sides of substrate. A first diaphragm 1116 and a second diaphragm 1116 and an integrated circuit 1124 are disposed within the assembly 1106. Terminals 1113 allow a customer to make connections from a hearing aid system to the assembly 1106. This arrangement creates a dual microphone for vibration cancelation with the microphones being in-phase for picking up sound and 180 degrees out of phase for the picking up of vibration. In this example, the integrated circuit 1124 is coupled to both motors (i.e., the first motor with the first diaphragm 1116 and the second motor with the second diaphragm 1131). In this case, the integrated circuit receives two different inputs and produces a single output signal. Alternatively, two separate integrated circuits can be deployed with one integrated circuit for each motor and thus two output signals (not shown).

Referring now to FIG. 14, one example of a side-by-side motor and circuit assembly 1400 is described. The assembly 1400 includes a first motor assembly 1406, a second motor assembly 1406, that may share a substrate 1408. These elements are disposed under a top cover (not shown) and bottom cover (not shown) that forms an overall ECM assembly. Customer terminals 1413 may be arranged as shown in the other example devices described herein.

Disposed over a first opening 1410 through the substrate is a first charged back plate 1414, a first diaphragm 1416, and a first stitch (not shown). Disposed over a second opening 1410 through the substrate is a second charged back plate 1414, a second diaphragm 1417, and a second stitch (not shown). As with the other examples described herein, a sound port is formed in the top cover and allows sound into the assembly 1400. The construction of the charged back plates 1414, and the diaphragms 1416 are well known to those skilled in the art. The stitches may be constructed of a conjoined B-stage adhesive and a polyimide (i.e. Kapton) and are configured to secure the charged back plates 1414 to the assembly 1400. The substrate 1408 is a ceramic substrate and includes a first diaphragm ring 1411 and a second diaphragm ring 1411 (which are part of and incorporated into the substrate 1408).

In one aspect, the diaphragm rings 1411 may be approximately 0.10 inches thick. Other dimensions may also be used. Wires 1422 couples the charged back plates 1414 to first and second integrated circuits 1424 via pads 1431. The integrated circuits 1424 may be application specific integrated circuits (ASICs) in one example. The integrated circuits 1424 may perform various processing functions such as amplifying the voltage produced.

It will be understood that the elements of the individual microphones shown in FIG. 14 are the same as the elements described with respect to FIGS. 1-7, but that in FIG. 14 two motors are disposed on the same substrate. It will be further understood that although two microphones are shown in FIG. 14, any number of microphones may be used. The functioning of these microphones may be the same or similar to the functioning of the microphone described with respect to FIGS. 1-7.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. An acoustic motor assembly, comprising:
a substrate with a diaphragm ring that is integrally formed with the substrate, the diaphragm ring forming an opening extending through the substrate;
an electrically charged plate extending over the opening;
a diaphragm extending over the opening and vertically displaced from the electrically charged plate;
a stitch coupling the electrically charged plate to the diaphragm;
wherein sound energy creates a movement of the diaphragm, the movement being effective to create an electrical signal representative of the sound energy.

2. The acoustic motor assembly of claim 1, wherein the substrate is constructed of a ceramic.

3. The acoustic motor assembly of claim 1, wherein the stitch is constructed of an epoxy.

4. The acoustic motor assembly of claim 1, wherein the electrically charged plate is generally rectangular having four corner areas and the stitch is coupled to the four corner areas.

5. The acoustic motor assembly of claim 1, further comprising an integrated circuit coupled to the substrate.

6. The acoustic motor assembly of claim 1, wherein the substrate is disposed in a housing and the housing has a sound port extending there through.

7. An acoustic motor assembly, comprising:
a substrate with a first diaphragm ring and a second diaphragm ring, the first diaphragm ring and the second diaphragm ring being integrally formed with the substrate, the first diaphragm ring forming a first opening extending through the substrate, the second diaphragm ring forming a second opening extending through the substrate;
a first electrically charged plate extending over the first opening;
a second electrically charged plate extending over the second opening;
a first diaphragm extending over the first opening and vertically displaced from the first electrically charged plate;
a second diaphragm extending over the second opening and vertically displaced from the second electrically charged plate;
a first stitch coupling the first electrically charged plate to the first diaphragm and a second stitch coupling the second electrically charged plate to the second diaphragm;
wherein sound energy creates a first movement of the first diaphragm and a second movement of the second diaphragm, the first movement being effective to create a first electrical signal representative of the sound energy and the second movement being effective to create a second electrical signal representative of the sound energy.

8. The acoustic motor assembly of claim 7, wherein the substrate is constructed of a ceramic.

9. The acoustic motor assembly of claim 7, wherein the first stitch and the second stitch are constructed of an epoxy.

10. The acoustic motor assembly of claim 7, wherein the first electrically charged plate is generally rectangular having four corner areas and the first stitch is coupled to the four corner areas.

11. The acoustic motor assembly of claim 7, further comprising a first integrated circuit coupled to the substrate and a second integrated circuit coupled to the substrate.

12. The acoustic motor assembly of claim 7, wherein the substrate is disposed in a housing and the housing has a sound port extending there through.
